(19) United States
(12) Patent Application Publication
(10) Pub. No.: US 2013/0343215 A1
(43) Pub. Date: Dec. 26, 2013

(54) Systems and Methods for Improving Channel Quality Indication Feedback Accuracy In Wireless Communication

(71) Applicants: Yingxue K. Li, San Diego, CA (US); Philip J. Pietraski, Huntington Station, NY (US); Joseph S. Levy, Merrick, NY (US); Hongsan Sheng, Chester Springs, PA (US)

(72) Inventors: Yingxue K. Li, San Diego, CA (US); Philip J. Pietraski, Huntington Station, NY (US); Joseph S. Levy, Merrick, NY (US); Hongsan Sheng, Chester Springs, PA (US)

(73) Assignee: INTERDIGITAL PATENT HOLDINGS, INC., Wilmington, DE (US)

(21) Appl. No.: 13/991,118

(22) PCT Filed: Dec. 2, 2011
(86) PCT No.: PCT/US2011/063052

§ 371 Date: Sep. 11, 2013

Related U.S. Application Data
(60) Provisional application No. 61/419,107, filed on Dec. 2, 2010.

(51) Int. Cl. H04W 72/08

(52) U.S. Cl. CPC H04W 72/085
USPC 370/252; 370/329

(57) ABSTRACT

Systems and methods for channel quality indicator (CQI) feedback may be disclosed. At a current transmission time interval, precoder and/or modulation information that may be used at or associated with a future transmission time interval may be determined. As such, at a current transmission time interval, precoder and/or modulation information that may be used to select a modulation or coding scheme (MCS) and/or schedule transmission at a future transmission time interval may be predicted in the current transmission time interval. The precoder and/or modulation information may be broadcast and received such that the information may be used to estimate a channel quality indicator (CQI) at the current transmission time interval. The estimated CQI may be used to select a modulation and coding scheme (MCS), schedule transmissions, and the like.

### CROSS-REFERENCE

This application claims the benefit of U.S. Provisional Patent Application No. 61/419,107, filed on Dec. 2, 2010, the contents of which are hereby incorporated by reference herein.

### BACKGROUND

Typically, wireless communication systems transmit and receive signals within a designated electromagnetic frequency spectrum. Unfortunately, the capacity of such a designated electromagnetic frequency spectrum tends to be limited. Additionally, the demand for wireless communication systems continues to increase and expand. As such, a number of wireless communication techniques have been developed to improve spectrum usage efficiency including improving the sensitivity of such systems to noise and interference. One such technique included in wireless communication systems to, for example, improve spectrum usage efficiency may include adaptive modulation and coding (AMC). For example, a receiver included such systems that may implement AMC may estimate a channel quality indicator (CQI) based on factors such as channel condition of a signal, interference, QAM module type, and the like. The estimated CQI may then be fed back to a transmitter included in such systems such that the transmitter may determine or select a modulation and coding scheme (MCS) for data transmission that may achieve or attain a desired block error rate (BLER) at the receiver. As such, the accuracy of the CQI may be important for accurate and proper selection of a MCS and for achieving a desired BLER to improve spectrum usage efficiency in such systems.

Unfortunately, due to processing durations and propagation delays at the transmitter and/or receiver, a gap or a feedback latency typically exists between when the CQI may be estimated at the receiver and when the CQI may be applied at the transmitter in such systems. Such feedback latency may cause difficulties in systems that may implement AMC including those with dominate interference sources such as a heterogeneous network deployment (HeNet). For example, such systems typically have a short duration period for transmission at the transmitter. Such a short duration period in combination with a feedback latency may cause the estimated CQI feedback to not be accurate, and, thus, transmission at the transmitter based on the CQI feedback may be less efficient (e.g. the CQI feedback, due to the short duration period and feedback latency, may show that a channel quality may not be good when, in fact, such a channel quality may actually be good thereby leading to the channel not being fully utilized by the transmitter, or the CQI feedback, due to the short duration period and feedback latency, may show that a channel quality may be good when, in fact, such a channel quality may not be good thereby leading to packet loss on a channel). As such, current systems that may implement AMC may be less efficient (and, thus, may not improve spectrum usage efficiency to the potential thereof) due, in part, from the accuracy of the estimated CQI that may be caused by short duration periods and feedback latency.

To address the accuracy of the estimated CQI that may be caused by short duration period and/or feedback latency, current wireless communication systems may provide a set of reference symbols such as a Resource-Specific Quality Indicator-Reference Symbol (RQI-RS) that may be used to estimate a CQI as shown in FIG. 1 and which will be described in more detail below. Unfortunately, the use of such reference symbols may increase overhead, may be insufficient for each of the receivers that may be included in a wireless communication system, and may not be backwards compatible with components of the wireless communication system.

### SUMMARY

Systems and methods for providing and improving channel quality indicator (CQI) feedback accuracy in a wireless communication system may be disclosed. According to an example embodiment, at a current transmission time interval, information such as a precoder information, modulation information including modulation type, interference information, coding information including coding schemes, and the like that may be used to or associated with a future transmission time interval may be determined by, for example, a transmitter or eNB. As such, at a current transmission time interval, information that may be used to schedule transmission or may be associated with transmissions at a future transmission time interval may be predicted in the current transmission time interval.

The information may then be broadcast by, for example, the eNB. According to an example embodiment, the information may be broadcast via a control channel such as a defined or special control channel provided or established by the eNB.

At a current transmission time interval, the information configured to be used at (or associated with) a future transmission time interval may be received by, for example, a user equipment (UE) such as a wireless transmit/receive unit (WTRU) associated with a user. A channel quality indicator (CQI) may then be estimated based on the information by, for example, the UE such that the estimated CQI may be reported, transmited, and/or broadcasted via, for example, the control channel. The estimated CQI may also be refined prior to reporting, transmission, and/or broadcasting.

The estimated CQI may be received by, for example, the eNB such that the eNB may select a modulation and coding scheme based on the estimated CQI, schedule data transmissions.

The Summary is provided to introduce a selection of concepts in a simplified form that are further described below in the Detailed Description. This Summary is not intended to identify key features or essential features of the claimed subject matter, not is it intended to be used to limit the scope of the claimed subject matter. Furthermore, the claimed subject matter is not limited to any limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 depicts a flow and timeline diagram of an example prior art method for estimating a channel quality indicator (CQI) in a wireless communication system;

FIG. 2 depicts a flow and timeline diagram of an example method for estimating CQI in a wireless communication system ;

FIG. 3a shows an example embodiment of a location of a channel where the channel from adjacent cells may not collide in frequency-time grid;

FIG. 3b shows an example embodiment a co-locating one or more channels on the same RB(s);

FIG. 4 illustrates an example system block diagram and method of a transmitter and a receiver for estimating CQI and co-locating a channel;

FIG. 5 depicts a flow and timeline diagram of another example method for estimating CQI in a wireless communication system;

FIG. 6 illustrates a graph depicting performance comparison for different interference modulation types;

FIG. 7 is a system diagram of an example communications system in which one or more disclosed embodiments may be implemented;

FIG. 8 is a system diagram of an example wireless transmit/receive unit (WTRU) that may be used within the communications system illustrated in FIG. 7;

FIG. 9 is a system diagram of an example radio access network (RAN) and an example core network that may be used within the communications system illustrated in FIG. 7;

FIG. 10 is a system diagram of a RAN and a core network according to an embodiment; and

FIG. 11 is a system diagram of another RAN and core network according to an embodiment.

### DETAILED DESCRIPTION

System and method embodiments are disclosed herein for providing CQI feedback in wireless communication systems. As described above, in current wireless communication systems, different channel qualities and a varying degree of interference typically exist between when a Channel Quality Indicator (CQI) may be generated at user equipment (UE) and when the CQI may actually be applied at a transmitter in the wireless communication system such as an evolved node B (or an eNB) due to feedback latency. Such a feedback latency may cause difficulties in wireless communications systems such as packet-switched wireless systems that may include dominate interference sources that may generate bursty or varying degrees of interference at a receiver or UE that may be associated therewith and/or a transmitter or an eNB that may be associated therewith. For example, when a UE may estimate a CQI at current transmission time interval (TTI) such as TTI N a certain amount or level of interference exists. The CQI may be estimated or generated based on that amount or level of interference. The estimated or generated CQI may then be transmitted by the UE and received by a transmitter such as an eNB. The transmitter such as the eNB may then select a modulation and coding scheme (MCS) that may be applied at TTI (N+n) or at a subsequent or future TTI such that a desired BLER (e.g., 10%) may be achieved. For such a wireless communication system to work as expected, the interference at TTI (N+n) should be similar to TTI N. Unfortunately, as described above, the interference may be different between TTI N and TTI (N+n). For example, an interference source at different TTIs such as TTI (N+n) and TTI N may be directed at or targeted to different users, and, thus, may result in different precoding matrices and effective channels at TTI (N+n) and TTI N. Additionally, bursty traffic may also lead to vacant resource blocks(RBs) that may cause interference levels to change from one TTI such as TTI N to another TTI such as TTI (N+n).

According to an example embodiment, to improve CQI feedback that may be caused by feedback latency (including discrepancy of interference levels or traffic caused by the feedback latency), a wireless communication system and/or components included therein may predict a transmission format and/or interference at a future or subsequent TTI ahead of time. For example, in the current TTI such as TTI N, a wireless communication system and/or components included therein may estimate a transmission format and/or interference in the wireless communication system, for example, at a transmitter, receiver, and/or a combination thereof for a future or subsequent TTI such as TTI (N+n).

Currently, to estimate or predict such a transmission formation or interference, a set of reference symbols such as Resource-Specific Quality Indicator-Reference Symbol (RQI-RS) may be used. For example, an eNB and/or a transmitter associated therewith may determine or generate a set of reference symbols such as RQI-RS. The set of reference symbols such as the RQI-RS may then be precoded, for example, the same way or in a similar manner as a data packet by the eNB or a transmitter associated therewith and broadcast or transmitted one or more TTIs ahead of or before the data packet (e.g. the set of reference symbols such as the RQI-RS may be broadcast in the current TTI (e.g. TTI N) and the data packet may be transmitted at a future or subsequent TTI (e.g. TTI (N+n)). The UE may receive (e.g. via a receiver included therein) the precoded set of reference symbols such as the RQI-RS that may be associated with a future transmission or future TTI such as TTI (N+n). In an example embodiment, the UE may estimate, determine, or predict (e.g. at the current TTI such as TTI N) potential future interference at the UE and a CQI at subsequent TTIs (e.g. at TTI (N+n)) based on the set of reference symbols such as RQI-RS.

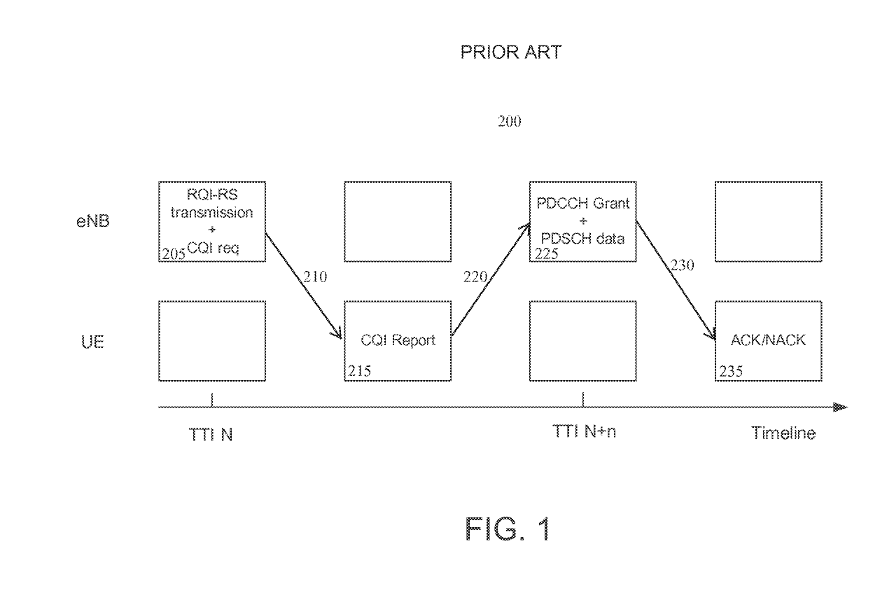

FIG. 1 depicts a flow and timeline diagram of an example prior art method 200 for estimating a channel quality indicator (CQI) in a wireless communication system using such reference symbols such as RQI-RS. As shown in FIG. 1, at 205, information or a transmission format associated with a subsequent or future TTI may be determined. For example, at 205, an eNB may determine (e.g. predict or estimate) in the current TTI (e.g. TTI N) a transmission precoding format (e.g. based on a set of reference symbols such as RQI-RS or interference) for a future or subsequent TTI (e.g. TTI N+n). Alternatively, any other suitable component or transmitter included in the wireless communication system may determine (e.g. predict or estimate) in the current TTI (e.g. TTI N) a transmission precoding format (e.g. based on a set of reference symbols such as RQI-RS or interference) for a future or subsequent TTI (e.g. TTI N+n).

At 210, the set of reference symbols such as RQI-RS associated with the transmission precoding format may be broadcasted or transmitted, for example, from a transmitter or an eNB to a receiver or a UE of a wireless communication system. The set of reference symbols or RQI-RS that may be transmitted at the current TTI such as TTI N may be precoded using a precoder that may be used for data precoding at a future or subsequent TTI such as TTI (N+n). Additionally, a request such as a Resource-Specific Quality Indicator (RQI) request may also be transmitted at 210. For example, at 210, an eNB or any other suitable component or transmitter included in a wireless communication system may transmit in the current TTI (e.g. TTI N) the set of reference symbols such as RQI-RS to a UE or other receiver component of the wireless communication system. The eNB may also transmit the request such as an RQI-request to UE or any other suitable component or receiver in the wireless communication system at 210.

Upon receiving the information and/or request, a CQI such as an RQI may be estimated at 215 by a receiver or component of a wireless communication system. For example, at 215, a UE or any other suitable component of a wireless communication system may estimate a CQI including a RQI from a cell associated with the UE.

After estimating the CQI at 215, the CQI may be transmitted at 220 by a receiver to, for example, a transmitter of a wireless communication system such as the wireless communication system 100. For example, a UE may transmit the CQI estimated to the eNB at 220. According to one embodiment, the CQI transmitted to the eNB at 220 may be in a report that may be used by the eNB to schedule transmissions.

At 225, the estimated CQI may be received, analyzed, used to assign transmission schemes such as MCS, and/or used to schedule transmissions including data, grants, and the like that may be transmitted. For example, the eNB may receive the CQI (e.g. via a report) and analyze the CQI at 225. The eNB may then assign (e.g. determine or selection) a modulation and coding scheme (MCS) based on the CQI that may match actual channel conditions associated with the eNB and/or that may achieve or attain a desired block error rate (BLER) at the UE. The eNB may further schedule transmissions based on the CQI and assigned coding schemes at 225.

At 230, data grants, and the like may be transmitted. For example, the eNB may transmit a grant, data, and the like on a channel such as PDCCH and/or PDSCH based on the CQI and/or MCS at 230.

As shown in FIG. 1, the data, grant, and the like may be received at 235 by a receiver and/or component of a wireless communication system. For example, the UE such may receive the data, grant, and the line. According to an example embodiment, in response to the reception of the data, grant, and the like, at 235, the UE may generate a positive acknowledgement (ACK)/negative acknowledgment (NACK) or other messages that may be transmited.

Although the method 200 may improve the short duration periods and feedback latency, and, thus, the accuracy of the CQI, the use of such reference symbols such as RQI-RS may increase overhead (e.g. may not be bandwidth efficient), may be insufficient for each receiver or UE that may be included in a wireless communication system, and may not be backwards compatible with components of a wireless communication system.

For example, the set of reference symbols such as the RQI-RS calculated or determined at 205 by, for example, the eNB or other suitable transmitter or component of a wireless communication system and transmitted at 210 to a UE may be associated with the same RB for which the CQI may be estimated by the UE. As such, the RQI-RS may be scattered across the system bandwidth of the wireless communication system such that each of the RBs included therein may be impacted and, thus, may increase system overhead and bandwidth and may reduce resource elements available to transmit data in a wireless communication system. Additionally, the set of reference symbols determined or calculated at 205 and transmitted at 210 may include information associated with interference power and spatial properties that may be sufficient for certain types of receivers included in a wireless communication system such as MMSE, MMSE-SIC to calculate or estimate CQI at 215, for example. However, for receivers that may employ maximum likelihood (ML) detection, such information may be insufficient to accurately calculate CQI as the CQI may also depend on modulation information including a modulation type (e.g., QPSK, 16QAM or 64QAM) of potential interference, which RQI-RS does not include. As such, at the current TTI (e.g. TTI N), the RQI-RS may not provide sufficient information to accurately estimate CQI for a future or subsequent TTI (e.g. TTI (N+n)).

Furthermore, the introduction of a set of reference symbols such as RQI-RS that may be calculated at 205 and transmitted at 210 may reduce the flexibility in scheduling a mix of receivers or UEs that may support the set of reference symbols such as RQI-RS and the legacy receivers or UEs. For example, the introduction of the set of reference symbols such as RQI-RS may not be supported by such legacy receivers or UEs that may be included in a wireless communication system. As such, the use of such reference symbols may cause performance loss to such legacy receivers or UEs as such legacy receivers or UEs may not be able to estimate a CQI based upon such reference symbols including RQI-RS.

Also, a receiver or a UE such may not be able to differentiate the set of reference symbols or RQI-RS calculated or determined at 205 and transmitted at 310 that may be associated with different neighboring cells from other data symbols (e.g. a regular data symbol) used in a wireless communication system such as the wireless communication system 100. While the set of reference symbols or RQI-RS may imply or suggest a scheduling and precoding decision made by neighbor or neighboring cells, other data symbols (e.g. a regular data symbol) included in a wireless communication system may cause ambiguity including ambiguity related to either a future or subsequent TTI (e.g. TTI (N+n)) not being scheduled to a UE or receiver or being scheduled to a legacy UE or receiver. As such, the interference estimation for a future or subsequent TTI (e.g. TTI (N+n)) may not be accurate in, for example, the wireless communication system using such reference symbols or RQI-RS.

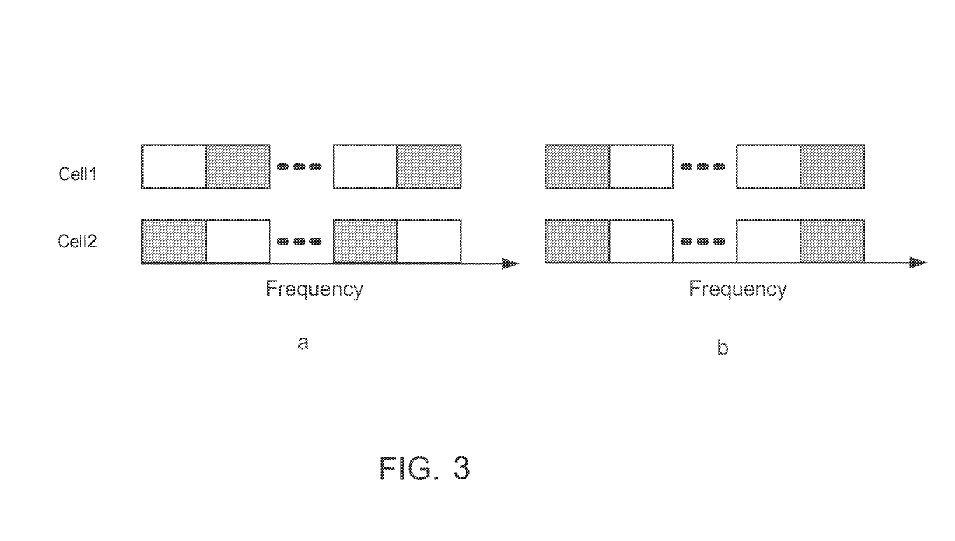

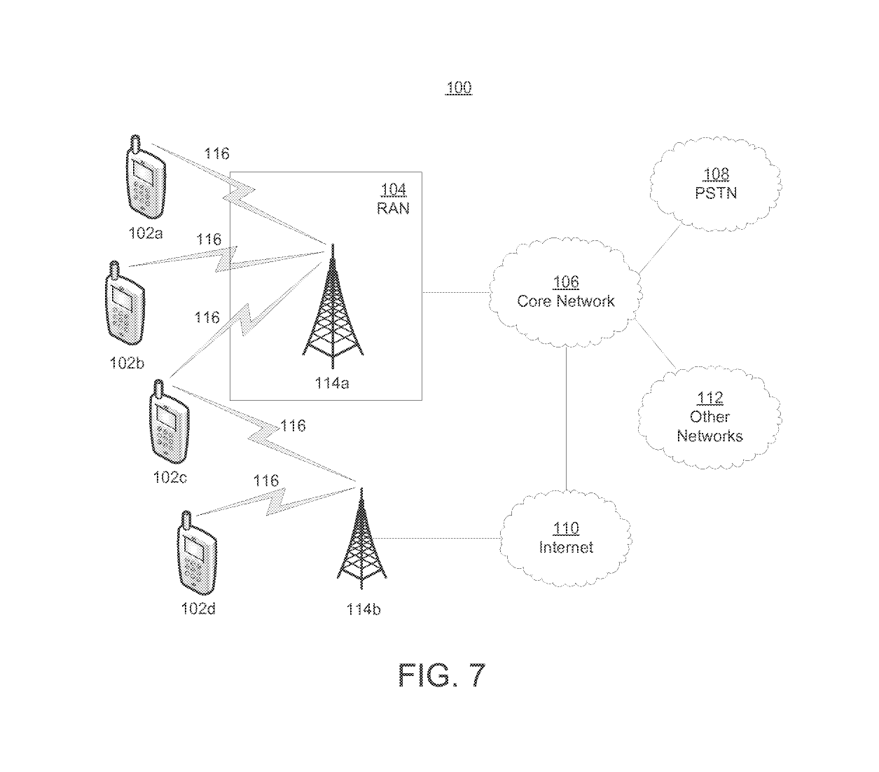

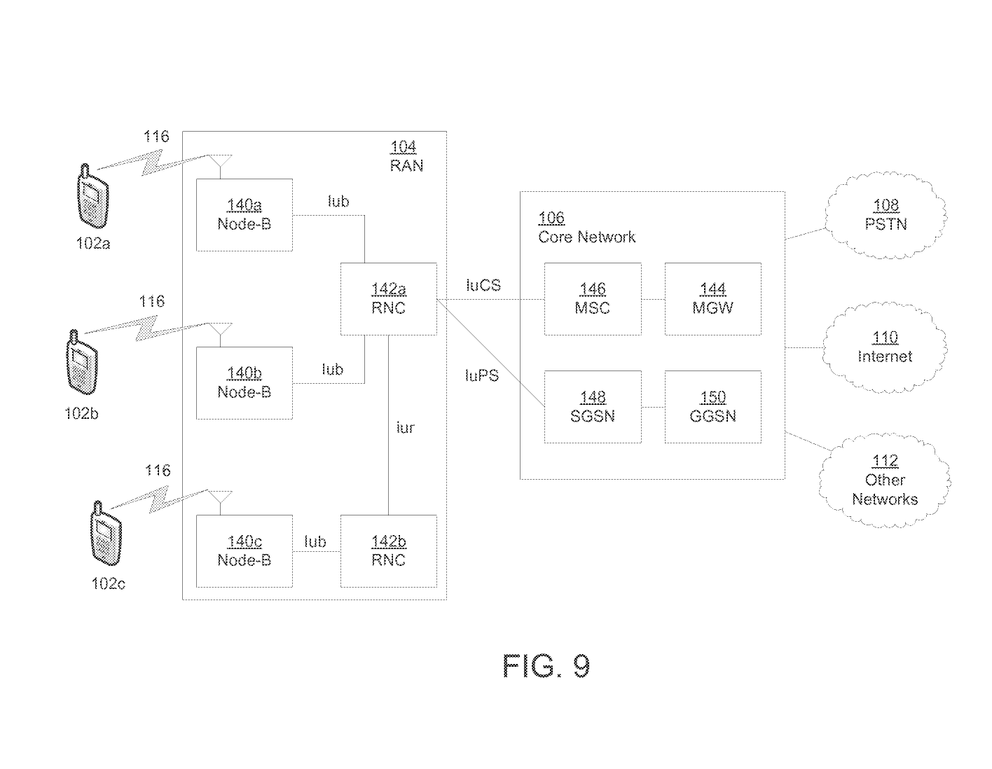

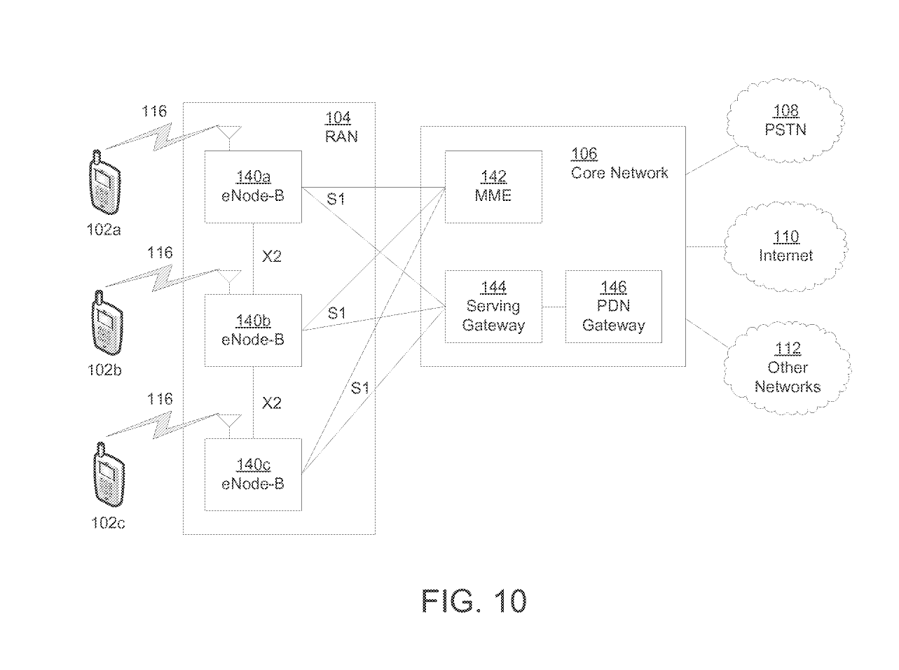

According to example embodiments, systems and methods disclosed herein may further improve the accuracy of the estimated interference, estimated CQI, and the like, may improve or reduce overhead and bandwidth constraints, may provide backwards compatibility for, for example, legacy receivers or UEs, and the like. For example, systems and methods disclosed herein may determine or estimate and send actual precoding information (e.g. not just a symbol or set of symbols such as RQI-RS that may be based on information including precoding information), modulation information, interference information, coding information, and the like for a future or subsequent TTI such as TTI (N+n) from a transmitter or eNB such as the eNB 140a-c shown in FIGS. 9-10 to a receiver or UE such as the WTRU 102 and 102a-d shown in FIGS. 7-11. According to one embodiment, such information may be provided by the eNB to the UE via a special control or downlink channel. For example, embodiments disclosed herein may provide a downlink common control channel in downlink (DCCCH) and may designate a number of RB to carry the DCCCH. Additionally, in an embodiment, a location of the RB may be cell specific and may be derived from cell ID (e.g. as shown in FIGS. 3a-3b, which will be described in more detail below). The DCCCHs may also be suitably placed among adjacent cells (e.g. as shown in FIGS. 3a-3b, which will be described in more detail below).

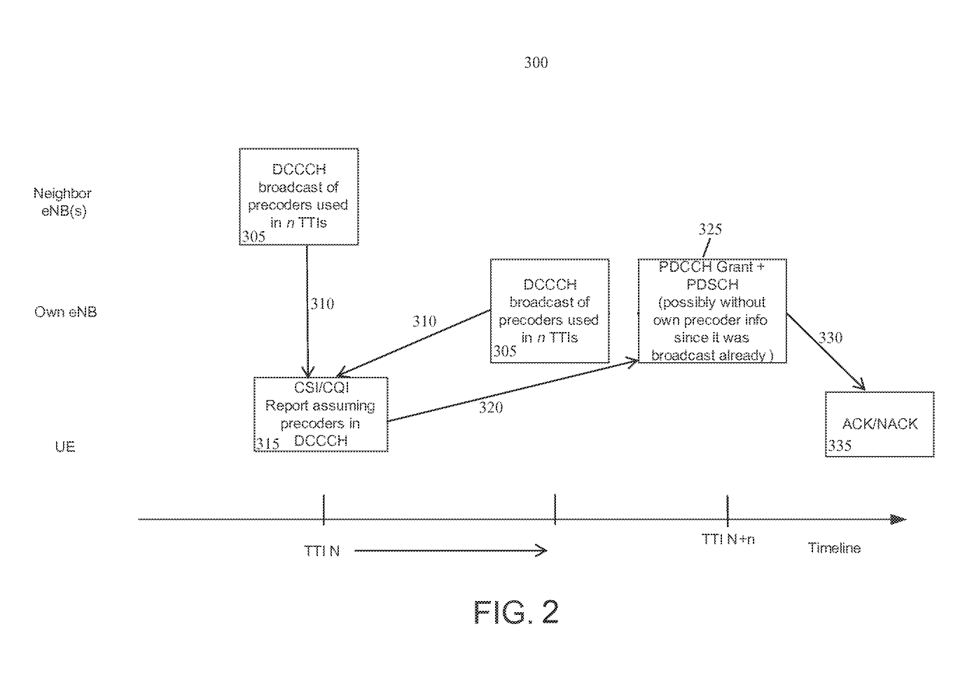

FIG. 2 depicts a flow and timeline diagram of another example method 300 for estimating CQI in a wireless communication system such as the wireless communication system 100 shown in FIG. 7. At 305, in the current TTI, precoder information and/or modulation information, interference information, coding information, and the like that may be associated with a subsequent or future TTI may be determined or estimated. For example, as shown in FIG. 2, an eNB and/or neighboring eNBs such as the eNBs 140a-140c shown in FIGS. 9-10 may establish and/or provide one or more control channels such as DCCCHs and one or more precoders associated therewith in a current TTI (e.g. TTI N) at 305. Also, at 305, in the current TTI (e.g. TTI N) information associated with the one or more precoders (i.e. precoder information) may be determined (e.g. predicted or estimated) for a future or subsequent TTI (e.g. TTI (N+n)). For example, at the current TTI (e.g. TTI N), the eNB and/or neighboring eNBs such as the eNBs shown in FIGS. 9-10 may determine (e.g. predict or estimate) precoder information for a future or subsequent TTI (e.g. TTI (N+n)). According to additional embodiments, any other suitable component or transmitter included in a wireless communication system such as the wireless communication 100 shown in FIG. 1 may determine in the current TTI precoder information that may be used or associated with a future or subsequent TTI.

In an example embodiment, the precoder information may be backward compatible (e.g. may not include a symbol or symbols such as RQI-RS that may not be recognized by each of the components of a wireless communication system) and may represent actual precoder information rather than a symbol or symbols such as RQI-RS shown and described above in FIG. 1. Additionally, the precoder information may be combined or lumped into a single transmission or single structure rather than being scattered across bandwidths like the symbol(s) or RQI-RS thereby reducing overhead and increasing bandwidth.

At 305, in the current TTI, the eNB and/or neighboring eNBs (or any other suitable component or transmitter included in a wireless communication system) may also determine modulation information, interference information, coding information, and the like that may be used or associated with a future or subsequent TTI.

At 310, the precoder information and/or modulation information, interference information, coding information, and the like that may be used by or associated with a future or subsequent TTI may be broadcast and/or transmitted. For example, at 310, the eNB and/or neighboring eNBs such as the eNBs 140a-c shown in FIGS. 9-10 may broadcast or transmit, in the current TTI (e.g. TTI N), the precoder information and/or modulation information, interference information, coding information, and the like for the future or subsequent TTI (e.g. TTI (N+n)). Alternatively, at 310, any other suitable component of a wireless communication system such as the wireless communication system 100 shown in FIG. 1 may broadcast or transmit, in the current TTI (e.g. TTI N), the precoder information and/or modulation information, interference information, coding information, and the like for the future or subsequent TTI (e.g. TTI (N+n)). At 310, a request such as a CQI request may also be broadcasted and/or transmitted by, for example, the eNB and/or neighboring eNBs or other suitable component of a wireless communication system. According to an example embodiment, the precoder information, modulation information, interference information, coding information, and the like and/or a request such as a CQI request may be broadcasted or transmitted on the control channels such as the DCCCHs described herein.

In example embodiments, the information such as the precoder information, modulation information, interference information, coding information, and the like may be broadcasted or transmitted at 310 on an as-need basis rather than being constantly broadcasted or transmitted as constantly transmitting such information at each TTI may not be bandwidth efficient

At 315, the information associated with a future or subsequent TTI such as the precoder information, modulation information, coding information, and the like and/or the request such as the CQI request, may be received in the current TTI. For example, a UE such as the WTRU 102 and 102a-d shown in FIGS. 7-11 may decode the DCCCHs of the cells or eNBs such as the eNB and/or neighboring eNBs in the current TTI (e.g. TTI N) at or near the time of channel quality indicator/channel state information (CQI/CSI) measurements such that the UE may receive the precoder information, modulation information, coding information, and the like associated with a future or subsequent TTI (e.g. TTI (N+n)) and/or the request at 315. According to another embodiment, any other suitable components of a wireless communication system such as the wireless communication system 100 shown in FIG. 1 may decode the DCCCHs in the current TTI (e.g. TTI N) at or near the time of CQI/CSI measurements such that the components may receive the precoder information, modulation information, coding information, and the like associated with a future or subsequent TTI (e.g. TTI (N+n)) and/or the request at 315.

Also, at 315, a CQI corresponding to a channel quality at the future or subsequent TTI may be estimated or determined in the current TTI. For example, at 315, the UE such as the WTRU 102 or 102a-d shown in FIGS. 7-11 and/or any other suitable component of a wireless communication system such as the wireless communication system 100 shown in FIG. 1 may estimate, in the current TTI (e.g. TTI N), a CQI associated with a future or subsequent TTI (e.g. TTI (N+n)). The CQI may correspond to a channel quality or estimated channel quality for the future or subsequent TTI (e.g. TTI (N+n)). In one embodiment, a frame structure may be provided or used (e.g. by the UE or eNB) to account for the CQI estimated at 315.

After estimating the CQI at 315, the CQI may be transmitted at 320. For example, a UE such as the WTRU 102 or 102a-d shown in FIGS. 7-11 or any other suitable component of a wireless communication system such as the wireless communication system 100 shown in FIG. 1 may transmit the CQI estimated to, for example, the eNB and/or neighboring eNBs such as the eNBs 140a-c shown in FIGS. 9-10 at 320. According to one embodiment, the CQI that may be transmitted at 320 may be in a report (e.g. a CQI report) that may be used to select a modulation and coding scheme (MCS) and schedule transmissions.

At 325, the estimated CQI or report associated therewith may be received, analyzed, used to assign and/or select transmission schemes such as a modulation and coding scheme (MCS) and/or used to schedule transmissions including data, grants, positive acknowledgement (ACK)/negative acknowledgements (NACK), and the like at the future or subsequent TTI. For example, at 325, the eNB and/or neighboring eNBs such as the eNBs 140a-c shown in FIGS. 9-10 may receive the estimated CQI or report associated therewith. After receiving the CQI or CQI report, at 325, the eNB and/or neighboring eNBs may compute one or more modulation, code rates, and the like based on the estimated CQI (e.g. included in the report) that may be used for downlink (DL) allocations in a cell associated therewith that may be used at, for example, TTI (N+n). In particular, at 325, the eNB and/or neighboring eNBs may assign (e.g. determine or select) a MCS based on the estimated CQI and report associated therewith that may be used at the future or subsequent TTI such that the MCS may match actual channel conditions associated with the eNB and/or neighboring eNBs and/or may achieve or attain a desired block error rate (BLER) at the UE in the future or subsequent TTI. Additionally, the eNB and/or neighboring eNBs may schedule transmissions in the future or subsequent TTI including selecting when and how much data may be transmitted based on the estimated CQI and assigned coding schemes at 325.

According to an example embodiment, at 325, remaining parts of an allocation if present may also be computed at 325 and, once n TTIs have elapsed, the PDCCH may transmit or broadcast the DL allocations (possibly in part since at least some information has already been broadcast) in the future or subsequent TTI (e.g. TTI (N+n)) at 330. Additionally, at 330, data, grant(s), and the like may be transmitted. For example, the eNB and/or neighboring eNBs such as the eNBs 140a-c shown in FIGS. 9-10 may transmit a grant, data, and the like on a channel such as PDCCH and/or PDSCH based on the estimated CQI and/or assigned MCS at 330. According to an example embodiment, at 335, the data, grant(s) and the like may be received by the UE such that the UE may generate an ACK/NACK and/or other messages in response to reception of the data, grant(s), and the like.

According to an example embodiment, the precoding information including a PMI and scheduling information for the future or subsequent TTI (e.g. TTI (N+n)) may be sufficient for a UE, receiver, and/or component of a wireless communication system such as linear MMSE or MMSE-SIC UEs, receivers, or components to estimate or derive and feedback an accurate CQI for UEs and receivers. However, when a UE, receiver, and/or component of a wireless communication system may implement or include a maximum likelihood (ML) receiver, additional information regarding the modulation type (e.g., QPSK, 16QAM, etc.) of the interference (i.e. modulation information as described above) may also be determined (e.g. predict or estimated) and used to derive or estimate CQI for a future or subsequent TTI (e.g. TTI (N+n)) and feedback thereof

As described above, in one embodiment, such precoder information, modulation information, interference information, coding information, and the like and/or request may be provided or broadcast by, for example, an eNB to the UE via a special control or downlink channel that may be decoded by the UE. For example, embodiments disclosed herein may provide a downlink common control channel in downlink (DCCCH) and may designate a number of RB to carry the DCCCH. According to another embodiment, the control channel such as the DCCCH may be accessible to users and UEs within the network that may in communication with the source of the control channel such as the eNB and transmitter included therein. The UE (and users thereof) may decode such a control channel and, in particular, control channels that may have a particular Signal-to-Noise Ratio (SNR) and may extract information such as precoder information, modulation information including modulation type, interference information, coding information including coding schemes, and the like.

According to an example embodiment, changes such as content carried by and channel format may be made on a channel such as a physical downlink control channel (PDCCH) such that information that may be transmitted or sent may not be duplicated. According to one embodiment, the PDCCH may be split into two parts such that a first part may be hearable to other components in the wireless communication system including UEs or eNBs in time for CQI feedback. Using the extracted information such as the extracted precoder information, the UE or user associated therewith may first predict or estimate the effective channel of desired signal and interferences, and then predict or estimate a CQI of future channel (e.g. at a future TTI) that may be used by the UE or experienced by the user in the future. According to another embodiment, rather than transmitting the precoder and modulation information, the control channel may include differential and/or scaling values for the future TTI (e.g. TTI N+n) using the current TTI (e.g. TTI N) as the reference point that may be used to estimate or predict the CQI at the UE.

Additionally, in an embodiment, a location of the RB may be cell specific and may be derived from cell ID (e.g. as shown in FIGS. 3a-3b, which will be described in more detail below). The DCCCHs may also be suitably placed among adjacent cells (e.g. as shown in FIGS. 3a-3b, which will be described in more detail below).

For example, FIG. 3a shows an example embodiment of a location of a DCCCH where the DCCCH from adjacent cells may not collide in frequency-time grid. Additionally, FIG. 3b shows an example embodiment of co-locating one or more DCCCHs on the same RB(s). As shown in FIG. 3b, a DCCCH associated with multiple cells may be separated by applying cell-specific interleaving or scrambling at a transmitter or eNB as well as applying successive interference cancellation at a receiver or UE, which will be described in more details below. Additionally, as shown in FIGS. 3a-3b, the impact of the DCCCH that may be provided herein may be limited to or associated with a few or small number of RBs such that the other RBs (i.e. the RBs that may not include the DCCCH) may not be impacted and may be backward compatible. According to an embodiment, if multiple RBs may be used to carry a payload, such RBs may be spread across the available bandwidth to maximize frequency diversity gain.

To determine the number of RBs that may be used for or with the DCCCH, 1) the bandwidth of a transmitter or eNB such as the eNB 140a-140c shown in FIGS. 9-10 may be used such that the number of RBs may be based on the bandwidth of the transmitter or eNB; 2) the type of transmitter or eNB may be used such that the number of RBs may be based on the on the type of eNB such as a high or low data rate, a high or low number of users, and the like; and/or 3) the eNB may define the RBs. The size and location of the DCCCH may be broadcast by the eNB, because of such flexibility. According to one embodiment, the locations/means of transmitting such size and location or may include in a physical broadcast channel (PBCH) as a mask for an existing control transmission, in an SIB, and/or as part of neighbor information provided to and/or from a transmitter or eNB such as a serving transmitter or eNB such that the potential interference (or interference information) that may be estimated may include consideration of ICIC or eICIC cooperation between the transmitters or eNBs that may be included in a wireless communication system such as the wireless communication system 100 shown in FIG. 7.

In example embodiment, content of the DCCCH disclosed herein may include future precoding information (i.e. the precoding information determined (e.g. predicted or estimated for a future or subsequent TTI) for each subband where the subband may be the minimum unit for scheduling and precoding of a receiver or UE and a bitmap indicating a future scheduling decision (e.g., 1 indicates that a particular or given RB may be and 0 indicates otherwise (i.e. not scheduled)). Additionally, the DCCCH and content thereof may carry precoding information that the reporting transmitter or UE may assume as present in the future or at a subsequent or future TTI such as TTI (N+n). The transmitter or eNBs used in the wireless communication system disclosed herein may then negotiate certain portions of bandwidth (BW) associated with the wireless communication system for which such precoding/scheduling information may be signaled.

According to yet another example embodiment, if or when the request such as the request that may be transmitted at 310 in FIG. 2 may be an aperiodic CQI request, the request may be accompanied by an indication of the precoding/scheduling that may be used when generating or estimating the CQI or report associated therewith at 315 in FIG. 2. Additionally, a periodic CQI configuration (e.g. if or when the request such as the request that maybe transmitted at 310 in FIG. 2 may be a periodic CQI request) may be include a listing of one or more signals associated with the DCCCH of a transmitter or eNB that may be analyzed or used and may also include the RBs where such signals may be found or present.

As described above, it may further be noted that a transmitter or eNB such as a serving eNB may coordinate with the surrounding cells to minimize interference on the DCCCH of other cells by, for example, not broadcasting data on the RBs associated with the RBs associated with the DCCCH of other cells. If the DCCCH may be truly a low overhead channel, a low overhead solution may be implemented or used to allow the reception of the DCCCH. Additionally, the DCCCH may be broadcasted and accessed by the receivers or UEs included in the wireless communication system if or when a SINR associated therewith may be large enough or meet a threshold such that no UE-specific scrambling should be applied. Cell-specific scrambling may also be applied according to an example embodiment.

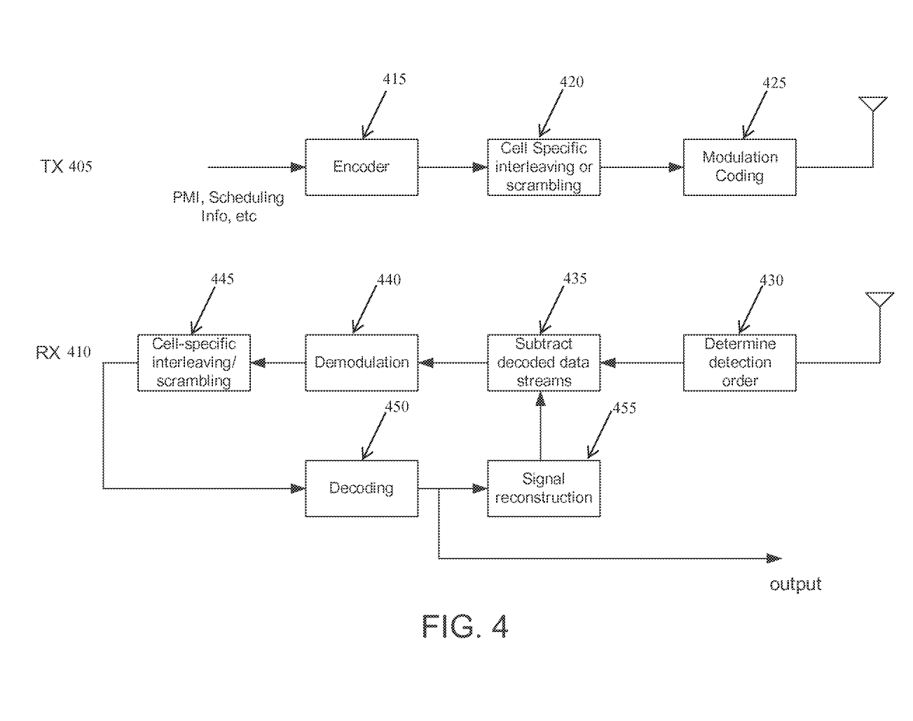

FIG. 4 illustrates an example embodiment of a system diagram for a transmitter Tx 405 such as an eNB and receiver Rx 410 such as an UE that may include DCCCHs that may be co-located in a wireless communication system for estimating CQI as described herein. As shown in FIG. 4, after a channel may be encoded (including CRC) by an encoder 415, the coded bits may be interleaved or scrambled according to a cell-specific pattern by an interleaving or scrambling component 420. The interleaved/scrambled bits may then be modulated by a modulation coding component 425 and transmitted therefrom.

According to an example embodiment, when multiple antennas may be used at the transmitter Tx 405, diversity schemes such as SFBC or CDD may be used. As described above, the information regarding the PDCCH transmission such as format/location and MCS, may be obtained by SIB and any other suitable method.

At the receiver Rx 410, the detection order may be determined (e.g. by a detection component 430 of the UE such as a processor included therein) according to, for example, signal strength. After a DCCCH is decoded, the DCCCH may be reconstructed and subtracted from the received signal via a subtraction component 435. For example, decoded data streams may be subtracted from a reconstructed signal associated with the DCCCH by the subtraction component 435. According to additional embodiments, more advanced receiver scheme may also be used to improve performance. For example, the receiver Rx 410 may employ an iterative receiver that may provide soft interference cancellation. A demodulation may then be performed by a demodulation component 440 on the data streams or bits such that cell specific interleaving or scrambling may be applied to by an interleaving or scrambling component 445. The interleaved or scrambled data streams or bits may then be decoded by a decoding component 450 such that a signal may be reconstructed by a signal reconstruction component 455 and the decoded data streams or bits may be transmitted or output.

According to an embodiment, the use of DCCCH as described herein may further improve the accuracy of the CQI estimation (e.g. using a set of reference symbols such as RQI-RS) with a smaller codebook and PMI. For example, with DCCCH, 400 bit PMI and 100 bit for scheduling info may be reduced and used. If QPSK modulation and ½ channel coding may also be provided in such a system, 4 RB may be used such that the overhead may be 4%. The overhead may further be reduced if the scheduling granularity may be reduced to more than 1 RB. With manageable performance loss, the overhead may be reduced even further by using a smaller codebook (e.g. less PMI bit(s)) in DCCCH as described herein for interference prediction that the codebook used for actual transmission. For example, the precoding matrices {Wi} may be represented by a single precoding matrix V, if the distance between Wi and V may smaller than a pre-determined constant. The distance may be defined as Chodal distance between two matrices. For example, a smaller codebook may be constructed for interference prediction which may be used by DCCCH. If an LTE rel.8 codebook may be used for data transmission, the rank-1 codebook (e.g. the smaller codebook) may include the 5^{th}, 6^{th}, 7^{th}, 8^{th} precoding matrix of the original codebook. A mapping shown in the example Table 1 below may be established. As shown in Table 1, only 2 bits may be used per PMI on a DCCCH.

TABLE 1

| | | | | |
|---|---|---|---|---|
| PMI to be used | W1, W5, | W2, W6, | W3, W7, | W4, W8, W12, |
| on PDSCH | W9, W13 | W01, W14 | W11, W15 | W16 |
| during TTI | | | | |
| (N + n) | | | | |
| PMI to be sent | W5 | W6 | W7 | W8 |
| on DCCCH | | | | |
| during TTI N | | | | |

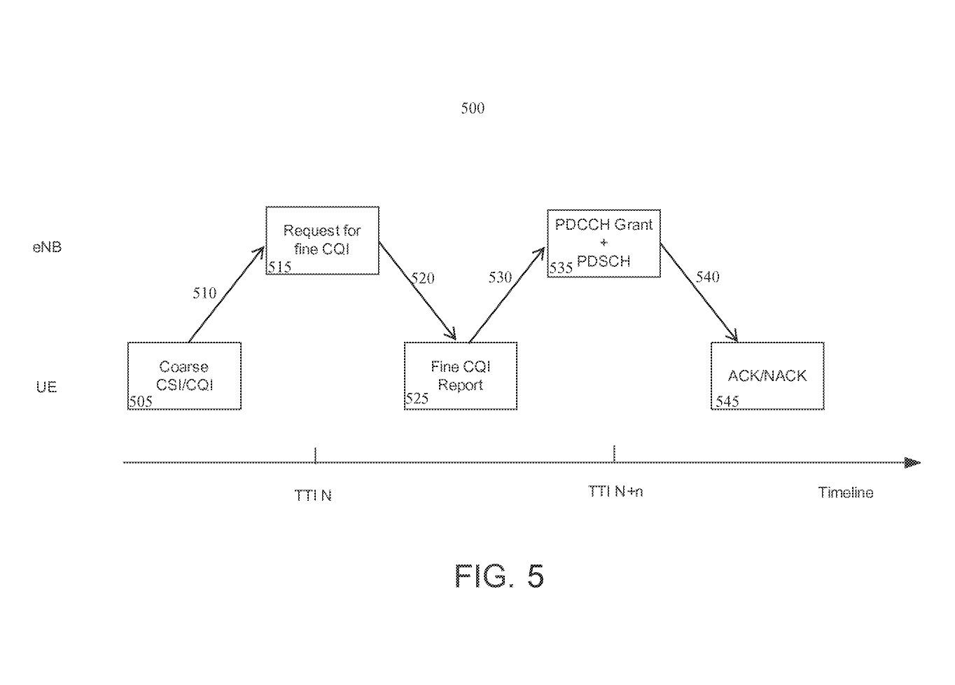

FIG. 5 depicts a flow and timeline diagram of another example method 500 for estimating CQI in a wireless communication system. As shown in FIG. 5, at 505, a coarse CSI and/or CQI may be estimated or determined by a UE such as the WTRU 102 and 102a-d shown in FIGS. 7-11 and may then be transmitted or sent at 510 to an eNB such as the eNB 140a-c shown in FIGS. 9-11 in the current TTI (e.g. TTI N). At 515, the eNB may then use coarse CSI and/or CQI to make a scheduling decision and in response thereto the eNB at 520 may send a request to the UE for a fine or refined CQI estimated or determined for the scheduled RB locations in the current TTI. At 515, the eNB may also determine precoder information, modulation information, interference information, coding information, and the like that may be used or associated with a future or subsequent TTI (e.g. TTI (N+n)) as described above in method 300 and may send, transmit, and/or broadcast such information at 420 (with, for example, the request). At 525, the UE may generate a refined CQI and may report the refined CQI in, for example, a CQI report to an eNB at 530 in the current TTI. According to one embodiment, the refined CQI report may generated or estimated be based on the scheduling decision, precoder information, modulation information, interference information, coding information, and the like. The refined CQI may then be transmitted from the UE to the eNB at 530. The eNB may then use the refined CQI report that may include such information at a future or subsequent TTI (e.g. TTI (N+n)) to select a MCS format at 535. At 535, a PDSCH may also be determined by the eNB and then transmitted, at 540, to the UE (and a grant may also be transmitted via a PDSCH). An ACK/NACK indication may also be determined by the eNB at 535 and transmitted back to the UE at 440 (and received thereby at 545) depending, for example, on CRC checking results.

According to an embodiment, for the UE to calculate a refined CQI, the UE may obtain or receive a neighbor list (e.g. a list of neighboring cells) through a process, such as, but not limited to, a cell search. For example, the UE may first determine a location or locations of a DCCCH or DCCCHs for a serving cell associated with the UE as well as other cells on the neighbor list (or a subset of the neighbor list that may have the strongest signals). The UE may then estimate unprecoded channel coefficients corresponding to the location(s) of the DCCCH(s) and cells and may demodulate and/or decode the DCCCHs involved or used. Information associated with the future precoding and scheduling information (e.g. the set of reference symbols such as RQI-RS that may be estimated at a current TTI (e.g. TTI N) for a future or subsequent TTI (e.g. TTI (N+n)) and information about neighbor or neighboring cells may then be extracted by the UE. The UE may then estimate the channel coefficients corresponding to the RBs for which CQI may be fed back or transmitted to an eNB or transmitter. The UE may also combine precoding/scheduling information and unprecoded channel coefficients to generate the effective channels and resulting refined CQI that may be used by a transmitter or UE to schedule transmissions.

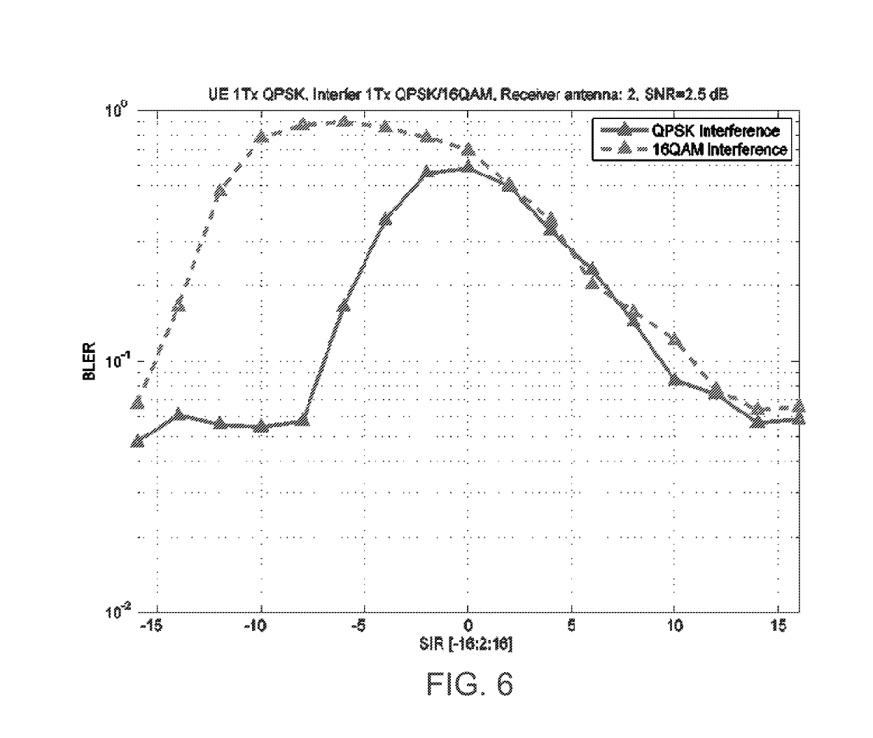

FIG. 6 illustrates a graph depicting performance comparison for different interference modulation types. Particularly, FIG. 6 shows an example that the performance of ML receiver depends on the modulation type of interference. At the same SIR level, 16 QAM may cause more damage than QPSK. Without the modulation type of the interferences, it may be difficult to estimate the accurate CQI for ML receivers.

To accurately predict the ML performance, the interference modulation information may be provided and used while calculating CQI. Such information may be combined with other information such as potential interference and/or a set of reference symbols such as RQI-RS and transmitted over DCCCH.

Besides being used as an input to calculate CQI, the modulation information may also be used to demodulate data in ML. As such, transmitting such information over DCCCH may not increase the overhead. In current systems, the modulation information may be transmitted over PDCCH channel and may be decoded by a single user. In the embodiments disclosed herein, the modulation information may be removed from PDCCH, and add to the DCCCH such that the modulation information may be decoded by each user if or when SNR may meet a threshold or be high or large enough.

FIG. 7 is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 7, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 7 may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 7, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 7, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 7 may be configured to communicate with the base station 114a, which may employ a cellular-based radio technology, and with the base station 114b, which may employ an IEEE 802 radio technology.

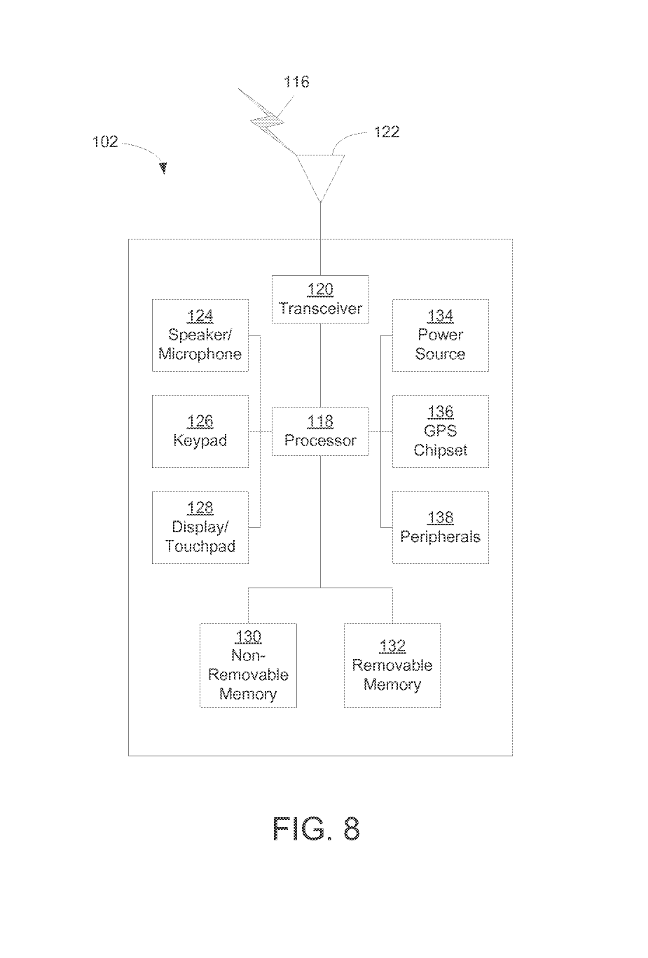

FIG. 8 is a system diagram of an example WTRU 102. As shown in FIG. 8, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 8 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 8 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 9 is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 9, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 9, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 9 may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 10 is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 10, the eNode-Bs 140a, 140b, 140c may communicate with one another over an X2 interface.

The core network 106 shown in FIG. 10 may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

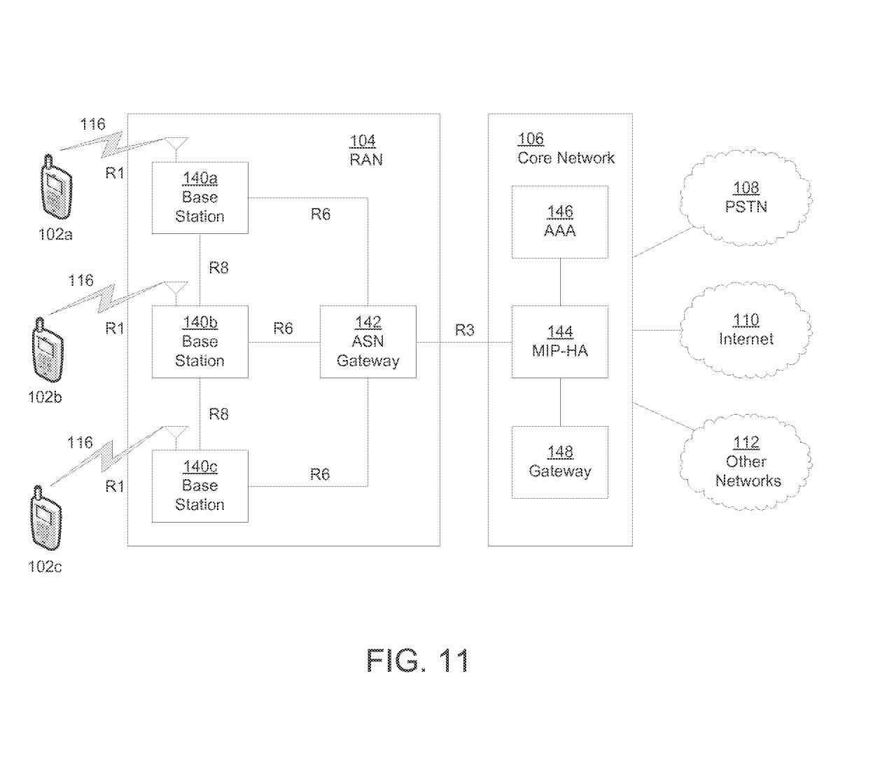

FIG. 11 is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 11, the RAN 104 may include base stations 140a, 140b, 140c, and an ASN gateway 142, though it will be appreciated that the RAN 104 may include any number of base stations and ASN gateways while remaining consistent with an embodiment. The base stations 140a, 140b, 140c may each be associated with a particular cell (not shown) in the RAN 104 and may each include one or more transceivers for communicating with the WTRUs 102a, 102b, 102c over the air interface 116. In one embodiment, the base stations 140a, 140b, 140c may implement MIMO technology. Thus, the base station 140a, for example, may use multiple antennas to transmit wireless signals to, and receive wireless signals from, the WTRU 102a. The base stations 140a, 140b, 140c may also provide mobility management functions, such as handoff triggering, tunnel establishment, radio resource management, traffic classification, quality of service (QoS) policy enforcement, and the like. The ASN gateway 142 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 140a, 140b, 140c may be defined as an R8 reference point that includes protocols for facilitating WTRU handovers and the transfer of data between base stations. The communication link between the base stations 140a, 140b, 140c and the ASN gateway 142 may be defined as an R6 reference point. The R6 reference point may include protocols for facilitating mobility management based on mobility events associated with each of the WTRUs 102a, 102b, 100c.

As shown in FIG. 11, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 144, an authentication, authorization, accounting (AAA) server 146, and a gateway 148. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 144 may provide the WTRUs 102a, 102b, 102c with access to packet-switched networks, such as the Internet 110, to facilitate communications between the WTRUs 102a, 102b, 102c and IP-enabled devices. The AAA server 146 may be responsible for user authentication and for supporting user services. The gateway 148 may facilitate interworking with other networks. For example, the gateway 148 may provide the WTRUs 102a, 102b, 102c with access to circuit-switched networks, such as the PSTN 108, to facilitate communications between the WTRUs 102a, 102b, 102c and traditional land-line communications devices. In addition, the gateway 148 may provide the WTRUs 102a, 102b, 102c with access to the networks 112, which may include other wired or wireless networks that are owned and/or operated by other service providers.

Although not shown in FIG. 11, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for providing channel quality indicator (CQI) feedback in a wireless communication system, the method comprising:
determining, at a current transmission time interval, precoder information estimated to be used in a future transmission time interval, wherein the precoder information comprises at least one of the following: one or more precoders, a precoding matrix indicator (PMI), or scheduling information estimated for use at the future transmission time interval;
broadcasting the precoder information configured to be used in the future transmission time interval;
receiving a channel quality indicator (CQI) estimated based on the broadcasted precoder information, wherein the CQI corresponds to an estimated channel quality at the future transmission time interval; and
selecting, based on the estimated CQI, a modulating and coding scheme (MCS) for transmissions configured to be applied in the future transmission time interval.

2. The method of claim 1, further comprising determining, at the current transmission time interval, at least one of the following: modulation information, interference information, and coding information associated with the future transmission time interval; and broadcasting at least one of the following: the modulation information, the interference information and the coding information.

3. The method of claim 1, wherein the MCS is selected to achieve a desired block error rate (BLER) at a user equipment (UE).

4. The method of claim 1, further comprising providing a defined control channel, wherein the precoder information is broadcast, at the current transmission time interval, via the defined control channel.

5. The method of claim 1, further comprising transmitting, based on the MCS or the estimated CQI, at least one of the following: data and a grant via at least one channel.

6. A wireless transmit/receive unit (WTRU) for providing channel quality indicator (CQI) feedback in a wireless communication system, the WTRU comprising:
a processor configured to:
receive, at a current transmission time interval, precoder information configured to be used in a future transmission time interval, wherein the precoder information comprises at least one of the following: one or more precoders, a precoding matrix indicator (PMI), or scheduling information estimated for use at the future transmission time interval;
estimate a channel quality indicator (CQI) corresponding to an estimated channel quality at the future transmission time interval based on the precoder information; and
transmit the estimated CQI, wherein the estimated CQI is configured to be used to select a modulation and coding scheme (MCS) at the future transmission time interval.

7. The WTRU of claim 6, wherein the processor is further configured to receive, at the current transmission time interval, at least one of the following: modulation information, interference information, and coding information; and estimate the CQI based on the precoder information and at least one of the following: the modulation information, interference information, and coding information.

8. The WTRU of claim 6, wherein the precoder information is received, at the current transmission time interval, via a defined control channel.

9. The WTRU of claim 8, wherein the processor is further configured to decode the precoder information received via the defined control channel.

10. The WTRU of claim 6, wherein the processor is further configured to receive at least one of the following: data, a grant, and a positive acknowledgement (ACK)/negative acknowledgement (NACK) transmitted based on the estimated CQI via at least one channel.

11. A method for providing channel quality indicator (CQI) feedback in a wireless communication system, the method comprising:
determining, at a current transmission time interval, information estimated to be used
in a future transmission time interval, wherein the information comprises precoder information and modulation information, wherein the precoder information comprises at least one of the following: one or more precoders, a precoding matrix indicator (PMI), or scheduling information estimated for use at a future transmission time interval and the modulation information comprises at least a modulation type estimated for use at the future transmission time interval;
broadcasting the information configured to be used in the future transmission time interval;
receiving a channel quality indicator (CQI) estimated based on the broadcasted information, wherein the CQI corresponds to an estimated channel quality at the future transmission time interval; and
selecting, based on the estimated COL, a modulating and coding scheme (MCS) for transmissions configured to be applied in the future transmission time interval, wherein the MCS is configured to achieve a desired block error rate (BLER) at user equipment (UE).

12. The method of claim 11, wherein the information further comprises at least one of the following: interference information and coding information.

13. The method of claim 11, further comprising providing a defined control channel, wherein the information is broadcast, at the current transmission time interval, via the defined control channel.

14. The method of claim 11, further comprising transmitting at a grant via one or more channels selected based on the estimated CQI.

15. The method of claim 11, further comprising:
transmitting data via a channel, wherein size of the data is selected based on the estimated CQI.
